(19) United States
(12) Patent Application Publication
(10) Pub. No.: US 2005/0124376 A1
(43) Pub. Date: Jun. 9, 2005

(54) Auxiliary guiding device for the blind

(76) Inventors: Ching-Hung Wu, Hsinchu Hsien (TW); Keng-Hau Chang, Hsinchu Hsien (TW); Nein-Chu Wu, Hsinchu Hsien (TW)

Correspondence Address: BIRCH STEWART KOLASCH & BIRCH, PO BOX 747, FALLS CHURCH, VA, 22040-0747, US

(21) Appl. No.: 10/779,611

(22) Filed: Feb. 18, 2004

(30) Foreign Application Priority Data
Dec. 8, 2003 (TW) 092134502

(51) Int. Cl. H04Q 7/20

(52) U.S. Cl. 455/550.1

(57) ABSTRACT

An auxiliary guiding device for the blind includes a guiding brick, a reader, text-to-speech (TTS) component and a power supply unit. The guiding brick is embedded with an electronic tag including a memory chip with a connected first antenna. The reader has a radio frequency transceiver module, a second antenna and a microprocessor, wherein the radio frequency transceiver module emits the energy of a radio wave to the electronic tag through the second antenna for driving the electronic tag to transmit the guidance information from the radio frequency transceiver module and then the microprocessor converts the guiding information to digital data. The TTS component has an input terminal of digital data for converting the digital data transmitted by the microprocessor to analog signals, such that the analog signals drive a voice synthesizer and the input digital data are broadcasted by means of speech.

### FIELD OF THE INVENTION

The present invention relates to an auxiliary guiding device for the blind, and more particularly to an auxiliary guiding device having a radio frequency identification system and a sound guiding function to assist the blind with navigating information (such as a district or a road name) at the current location.

### BACKGROUND OF THE INVENTION

In daily life, the blind have various methods of guidance via touch, such as Braille or a guiding stick. The information generated by touch is very limited. For example, when a blind person uses an elevator, guidance information informing how to push buttons and operate the elevator up and down is insufficient. Another example, tactile guiding strips disposed on sidewalks are insufficient in that they indicate a crossing but not direction or location. Furthermore, most of afore-mentioned guidance information is obtained by touch, passively providing the guidance information. The content this information is restricted, and therefore inconvenient and insufficient for navigation.

A “guiding device of a guiding brick having automatic notifying function in advance” is disclosed in Taiwan No. 433,295. The guiding device mainly includes a magnetic device that is mounted on a guiding stick and a guiding brick. Attractive or repulsive forces generated by of the opposing magnetic poles notify the blind in advance about the status of the road ahead.

The technology of the radio frequency identification system (RFID) is widely known and basically uses radio signals to transmit data. The radio frequency identification system mainly includes two portions, an electronic tag 10 and reader 20 (shown in FIG. 1) respectively. The principle is that the radio frequency transceiver module 201 of the reader 20 emits radio waves of a specific frequency to the electronic tag 10 through an antenna 202 to the electronic tag 10 and then the data and identification code stored in the chip 101 of the electronic tag 10 are transmitted. The reader 20 and electronic tag 10 have an alternating magnetic field between them to induce a current. The induced current in the antenna 102 of the electronic tag 10 is rectified and filtered by electronic components, such as diodes and capacitors, and then generates enough electric power to transmit data to the reader 20. Simultaneously, the reader 20 receives the data or identification code transmitted by the electronic tag 10 through the antenna 202 and the radio frequency transceiver module 201. Then, the data is processed by a microprocessor 203. For example, after the codes of the data are changed, the processed data is output to another device, such as a display or a data output device, connected to the reader 20.

The data transmitting functions between the reader 20 and the electronic tag 10 are to read the data stored in the chip 101 of the electronic tag 10 and write and edit data in the chip 101. U.S. Pat. No. 6,639,514 B1, entitled “Method For Selecting And Writing Into RFID-Transponders”, discloses the correlative technology for writing data. The advantage of the electronic tag 10 is it doesn't need a battery, doesn't need to be touched, doesn't need a special surface, and therefore doesn't get damaged. The secret code of a chip can't be copied, the safety is high, the chip life-time is long, therefore the radio frequency identification system is widely applied, and more recently, to animal chips, car chips that guard against burglaries, the restraint of entrance guard, the restraint of parking area, the automation of production line, the management of material and supplies, and so on.

Although the radio frequency identification system is widely used, most of radio frequency identification systems are used for the activities of the correlative business. There is no actual example how to solve the problem of walking for the blind by utilizing a radio frequency identification system.

Accordingly, there exists a need for an auxiliary guiding device for the blind to navigate safely.

### SUMMARY OF THE INVENTION

It is an object of the present invention to provide an auxiliary guiding device for actively assisting and guiding the blind by means of speech broadcasting.

It is another object of the present invention to provide an auxiliary guiding device for providing the blind with the corresponding geographical guidance or environment guiding information.

In order to achieve the foregoing objects, the present invention provides an auxiliary guiding device for the blind including a guiding brick, a reader, text-to-speech (TTS) component and a power supply unit. The guiding brick is embedded with an electronic tag including a memory chip and a first antenna connected to the memory chip, wherein the memory chip stores, reads, and writes guidance information. The reader has a radio frequency transceiver module, a second antenna and a microprocessor, wherein the radio frequency transceiver module emits the energy of a radio wave to the electronic tag through the second antenna to drive the electronic tag to transmit guidance information to the radio frequency transceiver module 411 and then the microprocessor converts radio signals to digital data. The TTS component has an input terminal of digital data to convert data transmitted by the microprocessor to analog signals, such that the analog signals drive a synthesizer and the input data broadcast as speech. The power supply unit provides the necessary power for the reader and TTS component.

The auxiliary guidance device for the blind according the present invention can update the guidance information stored in the memory chip of the electronic tag at any time by utilizing the data writing function of the reader. The guidance information includes the correlative geography guiding information or environment guiding information at the location of the guiding brick, such as a road name of an intersection, an important signpost, a direction to follow, and so on. Via the reader installed in the guiding stick, the blind get the guidance information stored in the guiding bricks.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a functional block diagram of radio frequency identification system (RFID) in the prior art.

FIG. 2 is a functional block diagram of an auxiliary guiding device for the blind according to a preferred embodiment of the present invention.

FIG. 3 is a sectional schematic view of a guiding brick embedded with an electronic tag.

FIG. 4 is a plan schematic view showing an embodiment of an arrangement of guiding bricks embedded with an electronic tag at an intersection.

FIG. 5 is a perspective exploded schematic view of a guiding stick according to a preferred embodiment of the present invention.

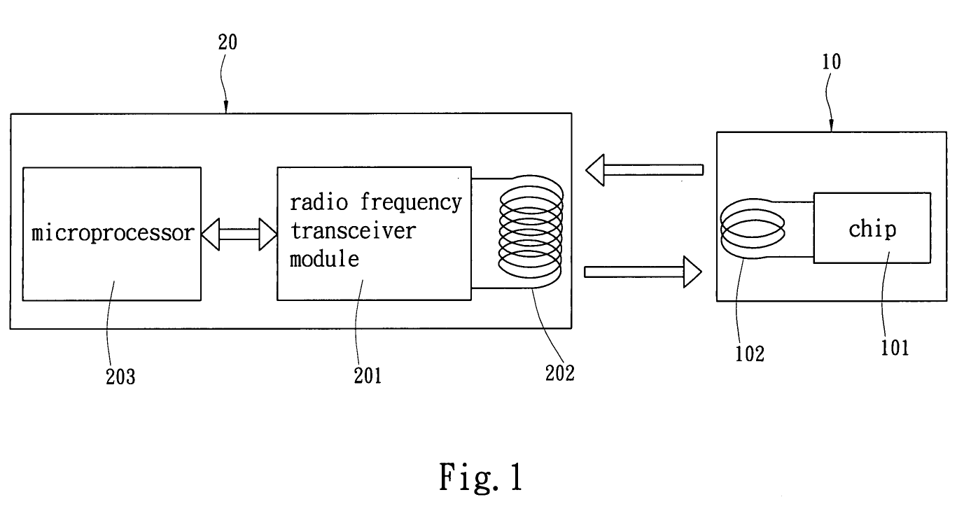

### DESCRIPTION OF THE PREFERRED EMBODIMENTS

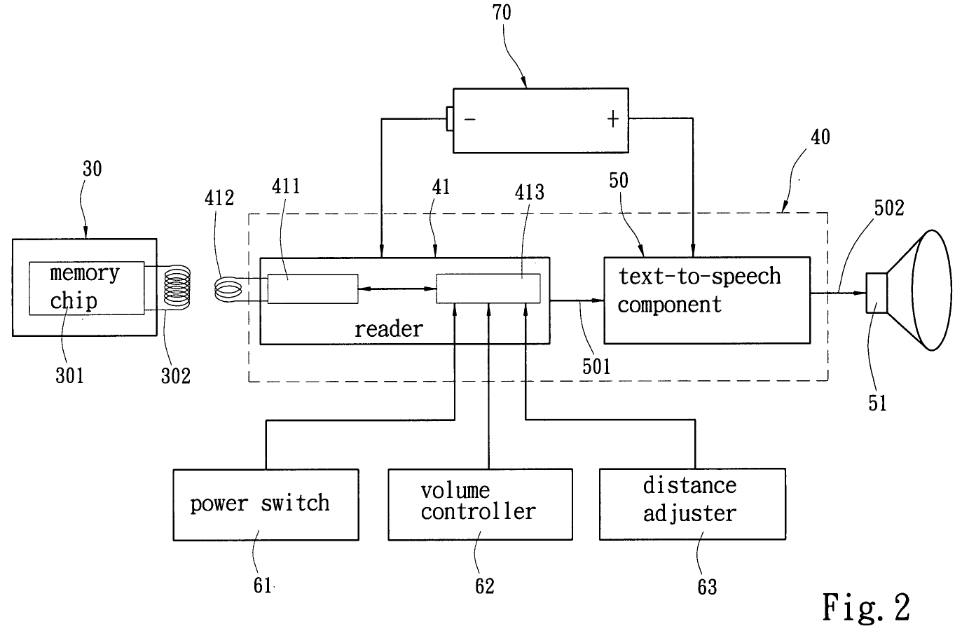

FIG. 2 shows a functional block diagram of an auxiliary guiding according to a preferred embodiment of the present invention. The auxiliary guiding stick includes an electronic tag 30 and a guiding unit 40.

The electronic tag 30 includes a memory chip 301 and a first antenna 302 connected to the memory chip 301. Basically, the memory chip 301 is a semiconductor component, can store, read, and write data.

The guiding unit 40 can emit radio waves to the electronic tag 30 for driving the electronic tag 30, and then the data stored in the memory chip 301 are transmitted, thereby reading the data stored in the memory chip 301 of the electronic tag 30 and actively notifying the blind by means of sound mode.

Recently, the technology of IC design has been extensively developed, and therefore the memory chip 301 of the electronic tag 10 not only has the basic memory components of semiconductors but also can be designed to have components, such as diodes and capacitors, to convert radio waves emitted by the guiding unit 40 to necessary electric power. Only the first antenna 302 (such as a printed circuit board or the winding of enamel-insulated wires) disposed on the surface of the electronic tag 30 can generate electric energy in the electronic tag 30 by means of an induced electromotive force, and therefore the electronic tag 30 does not need an additional power source or other component and for very low cost.

The guidance unit 40 includes a reader 41, a text-to-speech (TTS) component 50 and a power supply unit 70.

The reader 41 has a radio frequency transceiver module 411, a second antenna 412 connected to a radio frequency transceiver module 411, and a microprocessor 413. The radio frequency transceiver module 411 emits the radio waves with a specific frequency to the electronic tag 30 through the second antenna 202. The first antenna 302 and the second antenna 412 have an alternating magnetic field to induce a current. The UHF bandwidth (862˜928 MHz) emits a radio wave of the preferred embodiment of the present invention. The induced electromotive force in the first antenna 302 is generated by induction, is rectified and filtered by electronic components, such as diodes and capacitors, and then generates enough electricity that the electronic tag 30 can transmit data to the reader 20 through the second antenna 412 and the radio frequency transceiver module 411. Simultaneously, the reader 41 receives the data transmitted by the electronic tag 30 through the second antenna 412 and the radio frequency transceiver module 411, and then the data is converted to digital data by a microprocessor 413 and output.

Basically, the text-to-speech (TTS) component 50 is a TTS chip that has been developed. The TTS component 50 has an input terminal 501 of digital data for converting the digital data transmitted by the microprocessor 413 to analog signals, then an output terminal 502 outputs the analog signals. The analog signals drive a sound generating component 51 (such as a speaker, a buzzer or the like), and the input digital data are broadcasted by speech. Recently, the widely used TTS chip can receive the digital data with input format of uniform code (UNICODE) and broadcasts text from the data by via synthesized speech.

Basically, the power supply unit 70 is a battery for providing the necessary electric power to the afore-mentioned components.

In addition, according to the preferred embodiment of the present invention, the above-mentioned microprocessor 413 is further provided with an operating interface. The operating interface includes a power switch 61, a volume controller 62 and a distance adjuster 63. The user switches on or off the guiding unit 40 by utilizing the power switch 61, adjusts the output volume of the sound generating component 51 by utilizing the volume controller 62, and adjusts the reading distance between the reader 41 and the electronic tag 30 by utilizing the distance adjuster 63. The high frequency of UHF is used in the present invention, and therefore the reading distance is about a few meters.

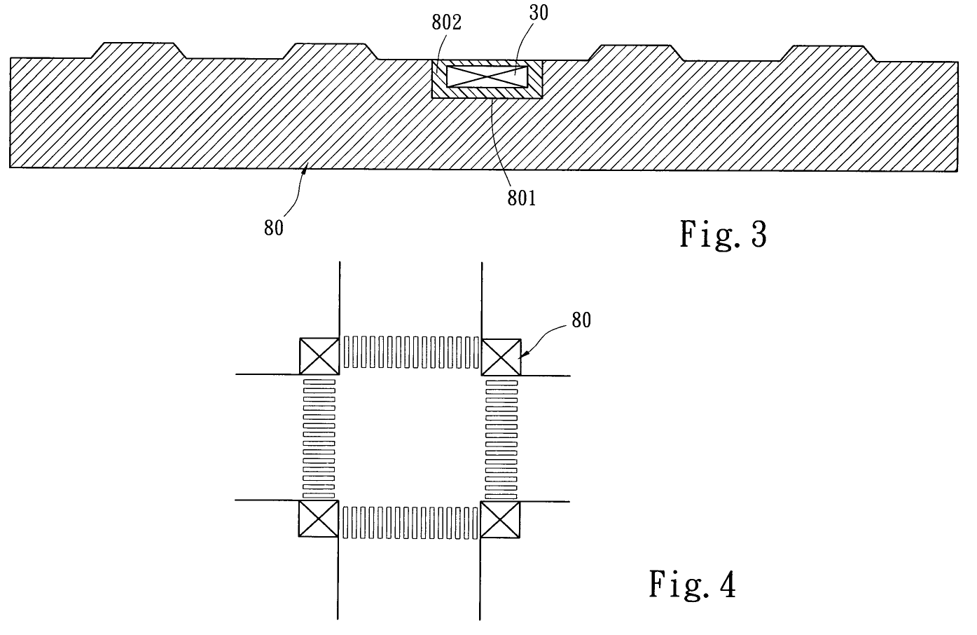

Referring to FIG. 3, a preferred embodiment that relates to the above-mentioned electronic tag 30 embedded in a guiding brick 80 in order to assist and guide the blind. According to the construction, a cavity 801 is formed in the guiding brick 80 by using a drill, or the cavity 801 is integrally formed in the guiding brick 80 in advance. Then, a watertight gel covers and seals the electronic tag 30 in the cavity 801. Basically, the building location of the guiding brick that is embedded with the electronic tag 30 can depend on the necessary geography, guidance information or external environment. For example, only four corners are the building locations according to a crossroads (shown in FIG. 4).

A responsible person can update the guidance information stored in the memory chip 301 of the electronic tag 30 at any time by utilizing the data writing function of the reader 41. The guidance information includes the correlative geography or description of the environment at the location of the guiding brick 80, such as the name of a road or intersection, an important signpost, a direction to follow, and so on. By utilizing the reader 41 installed in the guiding stick 90, the blind receives the information stored in the guiding bricks for safe navigation.

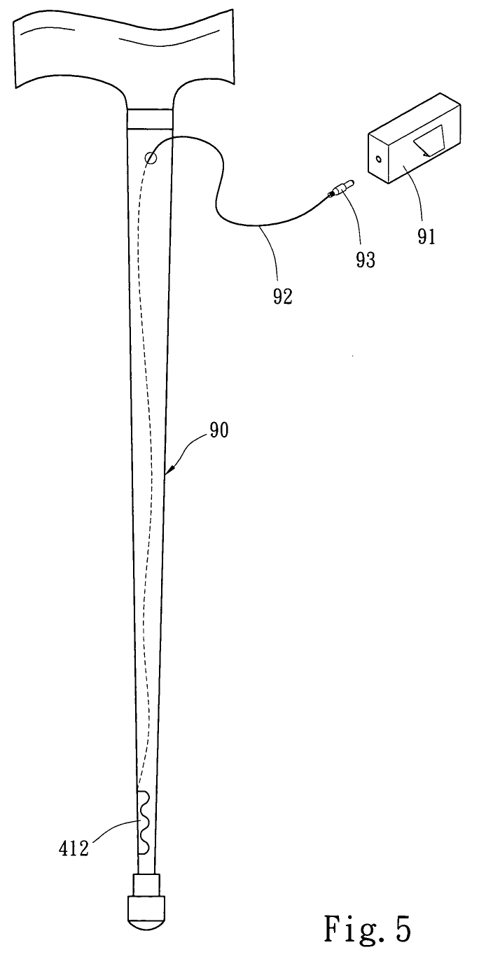

Referring to FIG. 5, it shows a preferred embodiment that the guiding unit 40 is installed in the guiding stick 90 for the blind, wherein the second antenna 412 is disposed around the bottom end (as close as possible) of the guiding stick 90 such that the second antenna 412 closely approaches the electronic tag 30 embedded in the guiding brick 80. In addition, the radio frequency transceiver module 411, the microprocessor 413, the TTS component 50 and the power supply unit 70 can be assembled into a portable container 91, thus a convenient wearable device. A typical connecting wire 92 connected the second antenna 412 to the radio frequency transceiver module 411 disposed in a container 91. The connecting wire 92 has connector, such as an earphone plug 93 to connect the radio frequency transceiver module 411 of the container 91 by means of assembling and disassembling for convenience.

The electronic tag is a component doesn't require a battery and (excepting for damage and breakdown) can be used for a long time.

Data stored in the electronic tag can be repeatedly read and written to, and therefore the guidance information thereof can be updated by a responsible person if necessary.

The reader is a high frequency transmitting device, and therefore the receiving distance of the reader is longer than that of lower frequency devices for example infrared. Furthermore, the reception distance can be varied according to the user's requirements.

Although the invention has been explained in relation to its preferred embodiment, it is not used to limit the invention. It is to be understood that many other possible modifications and variations can be made by those skilled in the art without departing from the spirit and scope of the invention as hereinafter claimed.

1. An auxiliary guiding device for the blind, comprising:
a guiding brick embedded with an electronic tag including a memory chip and a first antenna connected to the memory chip, wherein the memory chip stores guidance information which can be read or written;
a reader having a radio frequency transceiver module, a second antenna and a microprocessor, wherein the radio frequency transceiver module transmits radio waves to the electronic tag through the second antenna to trigger the electronic tag to transmit guidance information to the radio frequency transceiver module whereby the microprocessor then converts the guidance information to digital data;
a text-to-speech (TTS) component having an input terminal of digital data for converting the digital data transmitted by the microprocessor to analog signals, such that the analog signals drive a sound generating component and the inputted digital data are broadcasted by means of speech; and
a power supply unit for providing necessary electric power to the reader and the text-to-speech (TTS) component.

2. The auxiliary guiding device for the blind according to claim 1, wherein the guiding brick includes a cavity and a watertight gel for covering and sealing the electronic tag in the cavity.

3. The auxiliary guiding device for the blind according to claim 1, wherein the emitted frequency of the radio wave from transceiver module is 862˜928 MHz.

4. The auxiliary guiding device for the blind according to claim 1, wherein the microprocessor converts the digital data to digital data with uniform code (UNICODE) format and then transmits the digital data with uniform code (UNICODE) format to the input terminal of the text-to-speech (TTS) synthesizer.

5. The auxiliary guiding device for the blind according to claim 1, wherein the microprocessor includes a power switch.

6. The auxiliary guiding device for the blind according to claim 1, wherein the microprocessor further includes a volume controller for adjusting the output volume of the sound generating component.

7. The auxiliary guiding device for the blind according to claim 1, wherein the microprocessor further includes a gain function to adjusting the sensitivity between the reader and the electronic tag.

8. The auxiliary guiding device for the blind according to claim 1, wherein the power supply unit is a battery.

9. The auxiliary guiding device for the blind according to claim 1, wherein the radio frequency transceiver module, the microprocessor, the TTS synthesizer and power supply unit are assembled in a container being a portable device, such that a user wear the portable device.

10. The auxiliary guiding device for the blind according to claim 9, wherein the second antenna is disposed around the bottom end of the guiding stick and the reader has a connecting wire for connecting to the second antenna to the radio frequency transceiver module.

11. The auxiliary guiding device for the blind according to claim 10, wherein the connecting wire has connector to connect the radio frequency transceiver module by means of assembling and disassembling.
